(19) United States
(12) Patent Application Publication
(10) Pub. No.: US 2015/0149677 A1
(43) Pub. Date: May 28, 2015

(54) HOT PLUGGING SYSTEM AND METHOD

(71) Applicants: INVENTEC (PUDONG) TECHNOLOGY CORPORATION, SHANGHAI (CN); INVENTEC CORPORATION, TAIPEI (TW)

(72) Inventor: Tian-Chao ZHANG, Shanghai (CN)

(73) Assignees: INVENTEC (PUDONG) TECHNOLOGY CORPORATION, SHANGHAI (CN); INVENTEC CORPORATION, TAIPEI (TW)

(21) Appl. No.: 14/248,430

(22) Filed: Apr. 9, 2014

(30) Foreign Application Priority Data
Nov. 28, 2013 (CN) 201310627582.1

(51) Int. Cl. G06F 13/40

(52) U.S. Cl. CPC G06F 13/4081
USPC 710/302

(57) ABSTRACT

A hot plugging system and method are disclosed, in which a pluggable device transmits a request to a host before the pluggable device is pulled out so that the host may select whether preserving a device status, and preserves the device status and then shuts down a power of the pluggable device directly when preserving is selected while shuts down directly the power of the pluggable device when no preserving is selected so that the pluggable device is selected to be recovered or initialized according to the device status, existing or non-existing, after being inserted onto the host again, whereby achieving in a technical efficacy of promoting the hot plugging recovery.

### BACKGROUND OF THE RELATED ART

1. Technical Field

The present invention relates to a hot plugging system and method thereof, and particularly to a recovery capable hot plugging system and method thereof.

2. Related Art

Recently, with wide prevalence and vigorous development of semiconductor products, extension cards are generally provided to satisfy various requirements of users.

Typically, the extension card is connected to a bus of a main board for computer through a slot for additional functions to the main board, such as the functions of network, sound effect, TV, and magnetic disk control. As far as the bus standard is concerned, an industry standard architecture (ISA), a peripheral component interconnect (PCI), and the like are the examples of such additional functions. However, an insertion and pull actions on the extension card may possibly bring about damage to the card itself when the main board is being powered.

In response, there is a hot plugging manner proposed, which is used on, for example, PCI express and universal serial bus (USB), etc, through which the extension card is allowed to be inserted or pulled when the main board is continuously powered. This insertion or pulled action is called “hot plugging”. However, when an extension card is pulled and then inserted again, the extension card may only present as in a newly inserted status but not recover to the sate before being pulled. Therefore, there exists a recovery issue for the extension card on the main board.

In view of the above, it may be known that there is long a poor recovery issue of the hot plugging in the prior art, and thus there is quite a need to solve this problem.

### SUMMARY

The present invention discloses a hot plugging system and method are disclosed.

According to the present invention, the hot plugging system comprises a pluggable device, transmitting a request before being pulled out; and a host, comprising a detection module, choosing whether to preserve a device status according to the request after detecting the request; a power control module, preserving the device status and shutting down a power of the pluggable device when choosing to preserve the device status, and directly shutting down the power of the pluggable device when choosing not to preserve the device status; a pulling-out module, prompting the pluggable device to be pulled out when the power of the pluggable device is shut down, continuously detecting a connection status of the pluggable device, and switching the connection status from an inserted status to a pulled-out status when the pluggable device is pulled out; an insertion module, turning on the power of the pluggable device when the connection status is the pulled-out status and the pluggable device is detected; a recovery module, recovering a status of the pluggable device according to the device status when the device status exists, and initializing the sate of the pluggable device when the device sate does not exist; and a driving module, driving and instantiating the pluggable device according to the recovery module recovers or initialize the status of the pluggable device.

According to the present invention, the hot plugging method, applied on environment having a pluggable device and a host, comprises steps of transmitting a request by the pluggable deice before the pluggable device is pulled out from the host; and choosing by the host whether to preserve a device status according to the request after detecting the request; preserving the device status and shutting down a power of the pluggable device when choosing to preserve the device status, and directly shutting down the power of the pluggable device when choosing not to preserve the device status; prompting the pluggable device to be pulled out when the power of the pluggable device is shut down, continuously detecting a connection status of the pluggable device, and switching the connection status from an inserted status to a pulled-out status when the pluggable device is pulled out; turning on the power of the pluggable device by the host when the connection status is the pulled-out status and the pluggable device is detected; recovering a status of the pluggable device according to the device status when the device status exists, and initializing the sate of the pluggable device when the device status does not exist; and driving and instantiating the pluggable device according to the status of the pluggable device by the host.

The system and method of the present invention has the difference as compared to the prior art that the pluggable device transmits the request to the host before the pluggable device is pulled out so that the host may choose whether to preserve the device status, and preserves the device status and then shuts down the power of the pluggable device directly when preserving is selected while shuts down directly the power of the pluggable device when no preserving is selected so that the pluggable device is selected to be recovered or initialized according to the device status, existing or non-existing, after being inserted onto the host again.

By using of the above technical means, the present invention may achieve in a technical efficacy of promoting the hot plugging recovery.

### BRIEF DESCRIPTION OF THE DRAWINGS

The present invention will become more fully understood from the detailed description given herein below illustration only, and thus is not limitative of the present invention, and wherein:

FIG. 1 is a systematic diagram of a hot plugging system according to the present invention;

FIG. 2 is a flowchart of a hot plugging method according to the present invention; and

FIG. 3 is a schematic diagram illustrating how a host requests to pull out a pluggable device applied onto the present invention; and

FIG. 4 is a schematic diagram illustrating how the plugging device generates a request according to the present invention.

### DETAILED DESCRIPTION

The present invention will be apparent from the following detailed description, which proceeds with reference to the accompanying drawings, wherein the same references relate to the same elements. With reference to the detailed description, those skilled in the art may use the technical skill to solve the associated problem and thus achieve in the technical efficacy associated therewith, namely, may be enabled to implement the present invention.

Prior to the description of the hot plugging system and method disclosed in the present invention, nouns privately defined in this invention is first explained. The pluggable device of the present invention comprises a universal serial bus (USB) and a serial interface card, such as “express card”. Furthermore, the pluggable device has its electric regulations and protection measures meeting up with hot plugging.

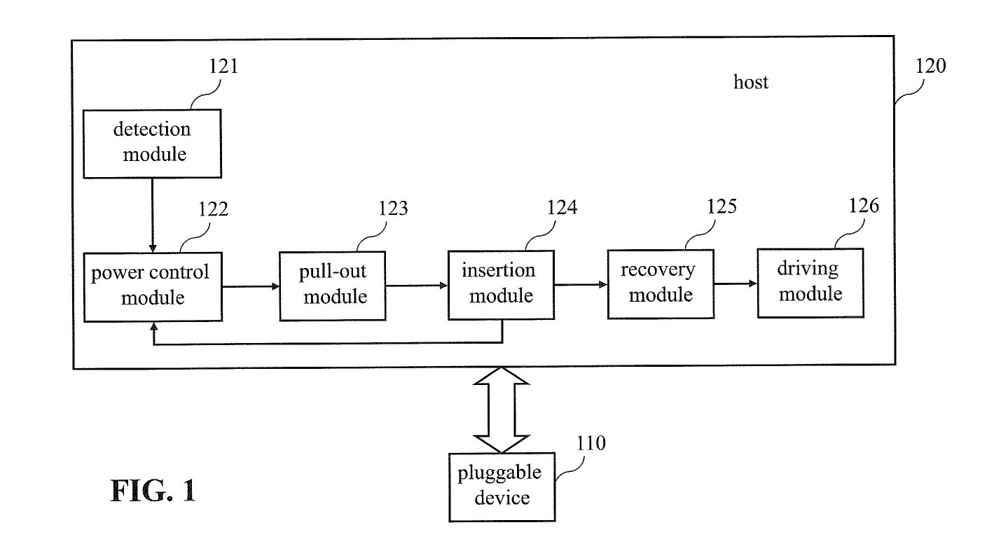

The hot plugging system and method of the present invention will be described in more details with reference to the figures. Referring to FIG. 1, in which a systematic block diagram of the hot plugging system is illustrated. The system comprises a pluggable device 110 and a host 120. The pluggable device 110 may use a bus of a computer when being inserted onto a slot of the computer, such as universal serial bus (USB) and peripheral interconnect express (PCI-E). In real implementation, before the pluggable device 110 is pulled out, an application program or a hardware, such as a button device, may be used to drive the pluggable device 110 to transmit a request. The request comprises a selection parameter representing whether to preserve a device status. For example, the selection parameter “1” represents that the device status is preserved, while “0” that the device status is not preserved. That is, a selection parameter may be preset in the request to provide the host 120 to select whether the device status is preserved.

The host 120 comprises a detection module 121, a power control module 122, a pluggable module 123, an insertion module 124, a recovery module 125 and a driving module 126. The detection module 121 selects whether the device status is preserved according to the request after detecting the request. As above mentioned, the request comprises a parameter representing whether the device status is preserved, and thus the detection module 121 may determine whether the device status is preserved.

The mentioned device status may comprise an arranging address of the bus and an address of a base address register (BAR), and the mentioned bus comprises the USB and PCI-E. In real implementation, it may be directly preset with a setting at the host 120 regarding whether the device status is preserved after receiving the request. And, if the setting exists at the host 120, the setting at the host 120 has the first priority for use.

The power control module 122 is used to preserve the device status and then shut down the power of the pluggable device, when the device status is selected to be preserved. Otherwise, when the device status is selected to be not preserved, then the pluggable device 110 is directly shut down on its power. In real implementation, when the device status is selected to be preserved, the power control module 122 will first read the device status of the pluggable device 110, and then store the device status into a storage element, such as a memory and a hard disk. Afterwards, a control signal is further transmitted to shut down the power of the pluggable device 110.

The pull-out module 123 is used to prompt the user to pull out the pluggable device 110 after shutting down the power of the pluggable device 110, and continuously detect a connection status of the pluggable device 110 to determine whether the pluggable device 110 has been pulled out by the user. When the pluggable device 110 has been pulled out by the user, the pull-out module 123 may switch the connection status from the inserted status into a pulled-out state.

The insertion module 124 may generate a power turn-on signal after the connection status is determined as having been pulled out and the pluggable device 110 is detected as having been inserted, and transmit the signal to the pluggable device 110 to enable the host to turn on the power of the pluggable device 110. Since the detection of the pluggable device 110 regarding its insertion or not is well know to the persons skilled in the art, it is omitted herein fro clarity.

The recovery module 125 is used to enable the host 120 to recover the sate of the pluggable device 110 according to the device status when the device status 125 exists. For example, the pluggable device 110 may be recovered to its status according to the arranging address of the bus and the address of the base address register in the device status. Otherwise, when the device status does not exist, the recovery module 125 may initialize the sate of the pluggable device 110.

The driving module 126 is used to recover or initialize the sate of the pluggable device 110 according to the recovery module 125, i.e. drive and instantiate the pluggable device 110. Since how the pluggable device 110 is driven and instantiated is well known to the persons skilled in the art, it is omitted herein for clarity.

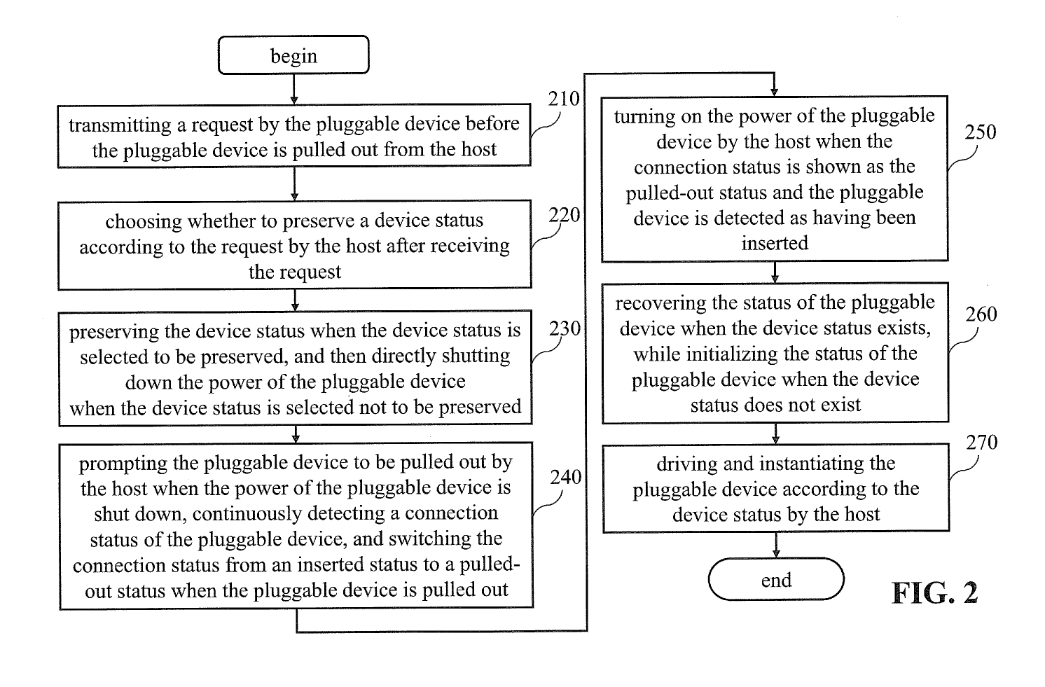

Thereafter, referring to FIG. 2, in which a hot plugging method according to the present invention is illustrated. The method comprises the following steps. At first, the pluggable device 110 transmits a request before the pluggable device 110 is pulled out from the host 120 (Step 210). After detecting the request, the host 120 selects whether to preserve a device status according to the request (Step 220).

When the device status is selected to be preserved, the device status is preserved and then the power of the pluggable device 110 is shut down. Otherwise, the power of the pluggable device is directly shut down when the device status is selected not to be preserved (Step 230).

When the power of the pluggable device 110 is shut down, the host 120 prompts the pluggable device 110 to be pulled out, and continuously detects a connection status of the pluggable device 110. Then, the connection status is switched from an inserted status to a pulled-out status when the pluggable device 110 is pulled out (Step 240).

When the connection status is shown as the pulled-out status and the pluggable device 110 is detected as having been inserted, the power of the pluggable device 110 is turned on by the host 120 (Step 250). When the device status does not exist, the status of the pluggable device 110 is initialized (Step 260). At this time, the host 120 drives and instantiates the pluggable device 110 according to the device status (Step 270).

By means of the above steps, the pluggable device 110 may transmit the request to the host 120 before the pluggable device 110 is pulled out, so that the host 120 may select whether the device status is to be preserved. And, when the selection is not to preserve the device status, the power of the pluggable device 110 is directly shut down, so that the pluggable device 110 is selected to be recovered or initialized according to the existence of the device status after the pluggable device 110 is inserted to the host 120 again.

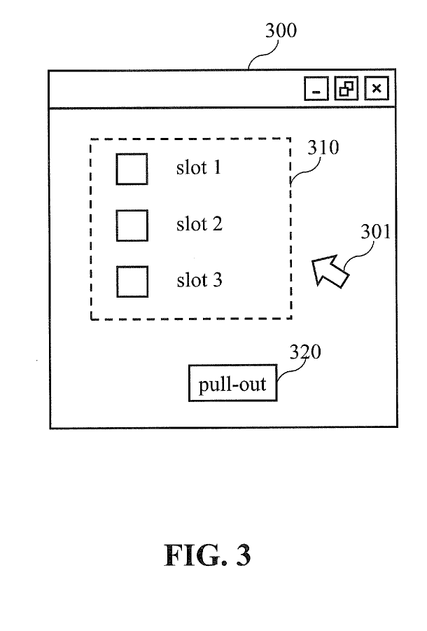

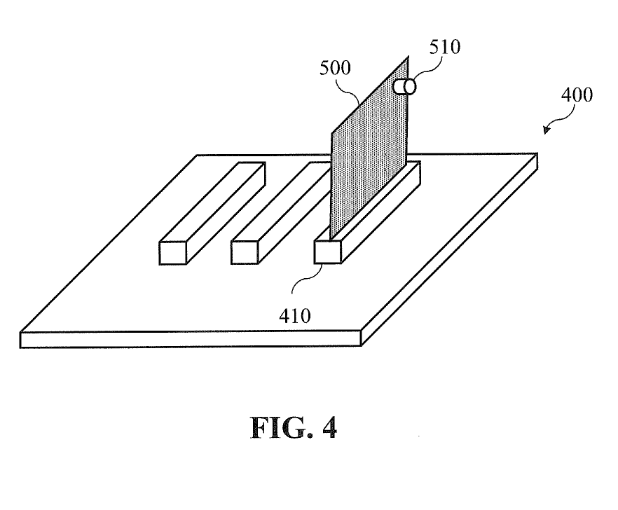

In what follows, an embodiment is set forth with reference FIG. 3 and FIG. 4 to explain how the present invention is operated. Referring first to FIG. 3, in which a schematic diagram illustrating how the host requests to pull out the pluggable device applied onto the present invention is shown. As mentioned above, before the pluggable device 110 is pulled out, the request is transmitted. In real implementation, the request may be generated by operating an operating window schematically shown in FIG. 3 to drive the pluggable device 110. For example, assume the user desires to pull out a pluggable device 110 fixed to a slot, then the user may use a cursor 301 to select “slot 1” within a selection area 310. Next, the cursor 301 further selects a pull-out button 320, the host 120 triggers the pluggable device 110 on slot 1 correspondingly to generate a request. When the host 120 detects the request, it may select whether the device status is preserved according to the request to continue the following process.

Referring to FIG. 4, which is a schematic diagram illustrating how the plugging device generates a request according to the present invention. In real implementation, assume the user desires to pull out the pluggable device 500 on “slot 1” 410 of the host 400, the user may first click a button 510, so that the pluggable device 500 will generate the request and transmit the request to the host 400. The request may be pre-arranged in the pluggable device 500 and transmit the predetermined request to the host 400 until the user clicks the button 510. Thereafter, when the host 400 detects the request transmitted from the pluggable device 500, it may select to preserve the device status according to the request. Assume the selection is to preserve the device status, the host 400 may preserve the device status of the pluggable device 500 and then shut down the power of the pluggable device 500.

Otherwise, when the selection is not to preserve the device status, the host 400 may directly shut down the power of the pluggable device 500. When the host 400 shuts down the power, it will prompt the user to pull out the pluggable device 500. At this time, the user may pull out the pluggable device 500 on the condition that the host 400 is still supplied with the power, and the host 400 will switch the connection status from “inserted state” to “pulled-out state”. Subsequently, when the user inserts the pluggable device 500 onto the slot 410, the host 400 will detect the pluggable device 500, and turn on the power of the pluggable device 400. If the host 400 has the device status stored, it may recover the status of the pluggable device 500 according to the device sate and drive and instantiate the pluggable device 500 according to the status. As such, the pluggable device 500 may be maintained at a status before being pulled out even having experienced a hot plug operation.

In view of the above, the system and method of the present invention has the difference as compared to the prior art that the pluggable device transmits the request to the host before the pluggable device is pulled out so that the host may select whether to preserve the device status, and preserves the device status and then shuts down the power of the pluggable device directly when preserving is selected while shuts down directly the power of the pluggable device when no preserving is selected so that the pluggable device is selected to be recovered or initialized according to the device status, existing or non-existing, after being inserted onto the host again, whereby solving the issue encountered in the prior art and achieving in a technical efficacy of promoting the hot plugging recovery.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A hot plugging system, comprising:
a pluggable device, transmitting a request before being pulled out; and
a host, comprising:
a detection module, choosing whether to preserve a device status according to the request after detecting the request;
a power control module, preserving the device status and shutting down a power of the pluggable device when choosing to preserve the device status, and directly shutting down the power of the pluggable device when choosing not to preserve the device status;
a pulling-out module, prompting the pluggable device to be pulled out when the power of the pluggable device is shut down, continuously detecting a connection status of the pluggable device, and switching the connection status from an inserted status to a pulled-out status when the pluggable device is pulled out;
an insertion module, turning on the power of the pluggable device when the connection status is the pulled-out status and the pluggable device is detected;
a recovery module, recovering a status of the pluggable device according to the device status when the device status exists, and initializing the status of the pluggable device when the device status does not exist; and
a driving module, driving and instantiating the pluggable device according to the recovery module recovers or initialize the status of the pluggable device.

2. The hot plugging system as claimed in claim 1, wherein the request is generated by pressing a button of the pluggable device or triggering the pluggable device through an application program by the host.

3. The hot plugging system as claimed in claim 1, wherein the request comprises a preset selection parameter for choosing whether to preserve the device status by the host.

4. The hot plugging system as claimed in claim 1, wherein the device status comprises an arranging address of a bus and an address of a base address register.

5. The hot plugging system as claimed in claim 4, wherein the bus comprises a universal bus (USB) and a peripheral component interconnect (PCI) express.

6. A hot plugging method, applied on environment having a pluggable device and a host, comprising steps of:
transmitting a request by the pluggable deice before the pluggable device is pulled out from the host; and
choosing by the host whether preserving a device status according to the request after detecting the request;
preserving the device status and shutting down a power of the pluggable device when choosing to preserve the device status, and directly shutting down the power of the pluggable device when choosing not to preserve the device status;
prompting the pluggable device to be pulled out when the power of the pluggable device is shut down, continuously detecting a connection status of the pluggable device, and switching the connection status from an inserted status to a pulled-out status when the pluggable device is pulled out;
turning on the power of the pluggable device by the host when the connection status is the pulled-out status and the pluggable device is detected;
recovering a status of the pluggable device according to the device status when the device status exists, and initializing the sate of the pluggable device when the device sate does not exist; and
driving and instantiating the pluggable device according to the status of the pluggable device by the host.

7. The hot plugging method as claimed in claim 6, wherein the request is generated by pressing a button of the pluggable device or triggering the pluggable device through an application program by the host.

8. The hot plugging method as claimed in claim 6, wherein the request comprises a preset selection parameter for choosing whether to preserve the device status by the host.

9. The hot plugging method as claimed in claim 6, wherein the device status comprises an arranging address of a bus and an address of a base address register.

10. The hot plugging method as claimed in claim 9, wherein the bus comprises a universal bus (USB) and a peripheral component interconnect (PCI) express.
